(19) United States
(12) Patent Application Publication
(10) Pub. No.: US 2020/0122792 A1
(43) Pub. Date: Apr. 23, 2020

(54) SEAL FOR ROTATING SLEEVE TRACK

(71) Applicant: Caterpillar Inc., Deerfield, IL (US)

(72) Inventors: Hong Lian, Peoria, IL (US); Mark J. Kiesel, Peoria, IL (US); Jason L. Sebright, Chillicothe, IL (US); Eric J. Johannsen, Washington, IL (US)

(73) Assignee: Caterpillar Inc., Deerfield, IL (US)

(21) Appl. No.: 16/168,732

(22) Filed: Oct. 23, 2018

(51) Int. Cl. B62D 55/088; B62D 55/092; B62D 55/21

(52) U.S. Cl. CPC B62D 55/0887; B62D 55/21; B62D 55/092

(57) ABSTRACT

A closed-loop seal having an irregularly shaped profile to seal a pivot assembly of a track assembly comprises a body comprising an inner diameter wall, an outer diameter wall, a first sidewall, and a second sidewall, wherein at least one pairing of the inner and outer walls and the first and second sidewalls are non-parallel. The irregularly shaped profile can comprise a curved rectangular profile or a trapezoidal profile. Walls of the body can be joined at curved surfaces having uniform or different radii of curvature. The seal can comprise urethane.

### TECHNICAL FIELD

The present application relates generally, but not by way of limitation, to track system components incorporated in or used with track-type treads used in various types of earth-moving machines, such as tractors, bulldozers, backhoes, excavators, motor graders, mining trucks, and other construction and agricultural machinery. More particularly, the present application relates to seals used in, for example, track joint assemblies that can engage with pivot assemblies used to couple adjacent track shoes.

### BACKGROUND

Machines used in mining, construction, agriculture, and like industries can be supported by an undercarriage assembly that can have one or more continuous track-type treads or “continuous tracks” that enable the machine to traverse the ground or terrain. The continuous track can include a plurality of track links that are pivotally joined or linked together by pins and bushings, for example, and that are arranged in a continuous loop or belt similar to a closed chain. The continuous track links can also include track shoes, which can include track pads disposed thereon, to engage the ground. The continuous track can be disposed around a plurality of rotating components, such as wheels, idlers and rollers, arranged within the undercarriage assembly along a lower side of the machine. The continuous track can be made to translate about the rotating components with respect to the machine by a drive sprocket operatively coupled to a prime mover such as an engine. A hinged connection between individual track links can form a pivot assembly that can enable the continuous track to articulate, e.g., flex or bend, as the continuous track moves in a loop about the plurality of rotating components, thereby bringing the track shoes into engagement with the ground.

An advantage of continuous tracks is that they can better support and distribute the weight of the machine due to the fact the continuous track provides more surface contact with the ground and thus better traction, as compared with other forms of propulsion such as pneumatic tires or wheels. Accordingly, continuous tracks can better traverse soft or loose soil or other materials without becoming stuck or spinning in place. In addition, the improved traction can improve climbing capability of the machine to drive along steep grades along the work surface. Further, because the individual track shoes and links are often made of steel, continuous tracks are typically more durable than pneumatic tires or the like.

To facilitate articulation of the track links so that the continuous track translates about the rotating elements and the drive sprocket, the individual track links can be joined by an appropriately designed track joint assembly. The track joint assembly can comprise combinations of pins, bearings, bushings and seals to facilitate pivoting of coupled track links while resisting wear.

Publication No. US 2015/0061373 A1 to Steiner et al., entitled “Joint Bushings For Track Joint Assemblies,” discloses a track joint assembly incorporating a plurality of bearings and seals for use in earth-working machines.

### SUMMARY OF THE INVENTION

A track joint assembly can comprise a first track link comprising a first through bore, a second track link comprising a second through bore and a counterbore, a pin extending through the first through bore and the second through bore, a first bushing surrounding the pin within the second through bore, a second bushing surrounding the first bushing adjacent the counterbore, and a seal disposed in the counterbore comprising a seal body surrounding the first busing, the seal body having an irregular cross-sectional area configured to non-uniformly seal a gap between the counterbore and the second bushing.

An O-ring seal having an irregularly shaped profile to seal a pivot assembly of a track assembly can comprise a body comprising an inner diameter wall, an outer diameter wall, a first sidewalk and a second sidewalk wherein at least one pairing of the inner and outer walls and the first and second sidewalls are non-parallel.

A bushing assembly for a track assembly can comprise an inner bushing having an outer diameter surface, an outer bushing having a through bore extending from a first end of the outer bushing to a second end of the outer bushing and defining an inner diameter surface, a passage disposed between the outer diameter surface and the inner diameter surface, and a closed-loop seal having a non-uniform cross-sectional profile located on the outer diameter surface against the first end of the outer bushing to seal the passage.

### BRIEF DESCRIPTION OF THE DRAWINGS

FIG. 1 is a perspective view of a track-type machine comprising a tractor and an undercarriage including track joint assemblies having seals of the present application.

FIG. 2. is an exploded view of a track assembly of FIG. 1 comprising track shoes, track links and pivot assemblies including seals of the present application.

FIG. 3 is a cross sectional view of the track joint assembly of FIG. 2 showing locations for seals of the present application between a track link and an outer track bushing against an inner track hushing.

FIG. 4 is a side view of a first embodiment of an irregularly-shaped seal for use in the track joint assembly of FIG. 3 comprising a curved rectangular profile.

FIG. 5 is a cross-sectional view of the seal of FIG. 4 showing the curved rectangular profile.

FIG. 6 is a cross-sectional view of the seal of FIG. 4 located within a track joint assembly in an uncompressed state.

FIG. 7 is a cross-sectional view of the seal of FIG. 4 located within a track joint assembly in a compressed state.

FIG. 8 is a side view of a second embodiment of an irregularly-shaped seal for use in the track joint assembly of FIG. 3 comprising a trapezoidal profile,

FIG. 9 is a cross-sectional view of the seal of FIG. 8 showing the trapezoidal profile.

FIG. 10 is a cross-sectional view of the seal of FIG. 8 located within a track joint assembly in an uncompressed state,

FIG. 11 is a cross-sectional view of the seal of FIG. 8 located within a track joint assembly in a compressed state.

### DETAILED DESCRIPTION

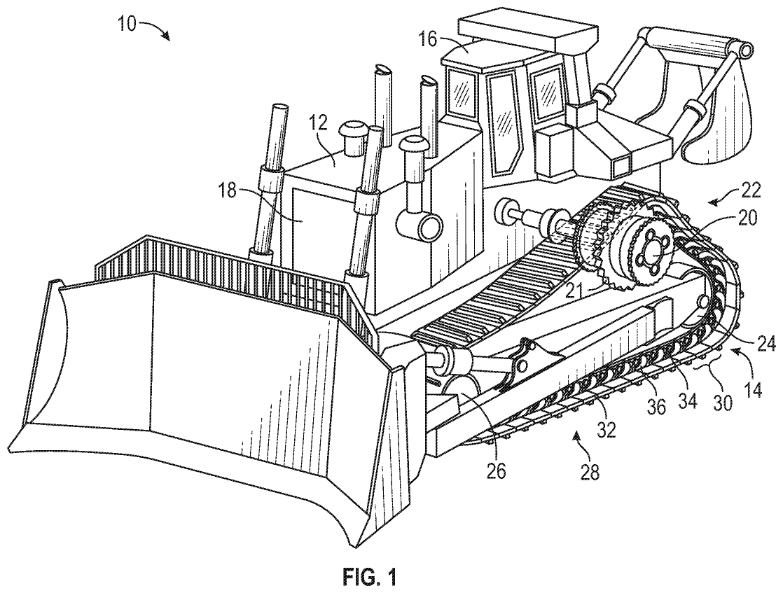

FIG. 1 is a perspective view of track-type machine 10 comprising tractor 12 and tracked undercarriage 14 including seals of the present application. Tractor 12 can comprise cabin 16 and power source 18. Power source 18 can be coupled to drive or power sprocket 20 of tracked undercarriage 14 to drive or power track system 22. Track system 22 can further comprise rear idler 24, front idler 26 and track chain 28. Track chain 28 can comprise a plurality of track joint assemblies 30, each of which can comprise one or more of shoes 32, pivot assemblies 34 and track links 36.

Machine 10 can comprise a mobile machine that performs an operation associated with an industry such as mining, construction, farming, or any other industry known in the art that utilized track-type machines. For example, machine 10 can be an earth-moving machine such as a dozer, a loader, an excavator, or any other earth-moving machine.

Power source 18 can drive tracked undercarriage 14 of machine 10 at a range of output speeds and torques. Power source 18 can be an engine such as, for example, a diesel engine, a gasoline engine, a gaseous fuel-powered engine, or any other suitable engine, Power source 18 can be a non-combustion source of power such as, for example, a fuel cell, a power storage device, or any other source of power known in the art.

Tracked undercarriage 14 can include a pair of track chains 28 (only one of which is visible in FIG. 1) each driven by power source 18 via a sprocket. For example, track chain 28 can be driven by sprocket 20. Sprocket 20 is schematically illustrated in FIG. 1 connecting to track system 22 from inside tractor 12. Shoes 32 of each track chain 28 can be configured to engage ground or terrain traversed by machine 10. Sprockets 20 can engage and transmit torque to pivot assemblies 34 to thereby move track chain 28 about spaced apart idlers 24 and 26. For example, sprocket 20 can include teeth 21 for engaging bushings on pivot assemblies 34 to push track shoes 32. Bushings within pivot assemblies 34, for example, can include sealing arrangements as described herein.

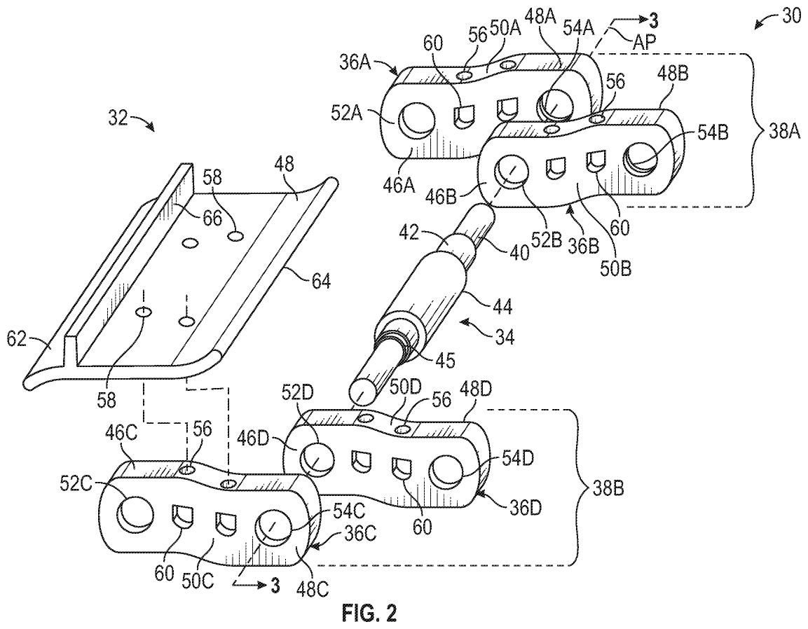

FIG. 2 is an exploded view of track joint assembly 30 of track chain 28 of FIG. 1 comprising track shoe 32, pivot assembly 34 having seals of the present application and track links 36A, 36B, 36C and 36D. Track assembly 30 can comprise opposing sides 38A and 38B. Pivot assembly 34 can comprise pin 40, inner bushing 42, outer bushing 44 and thrust ring 45.

Side 38A can comprise links 36A and 36B and side 389 can comprise links 36C and 36D. Sides 38A and 38B can be pivotably coupled by pivot assembly 34 to rotate about pivot axis A_{P}. Links 364 and 36C can be coupled by track shoe 32 and links 36B and 36D can be coupled by another track shoe 32 (not illustrated in FIG. 2). As illustrated, track joint assembly 30 is disposed to translate to the left in FIG. 2 in a longitudinal direction transverse to pivot axis A_{P} as part of the top of track chain 28 and then rotate downward so that face 48 can engage a ground surface as track chain 28 moves in the longitudinal direction.

Sides 38A and 38B can be disposed opposite each other and can be connected by one or more pivot assemblies 34. Track links 36A-36D can be identical to each other, with track links 36A and 36B being disposed in a mirror image orientation to track links 36C and 36D. Track links 36A 36D can have “bent” or angled profiles such that forward ends (e.g., to the left in FIG. 2) and rearward ends (e.g., to the right in FIG. 2) are offset from each other. The rearward ends can be wider than the forward ends, relative to pivot axis A_{P}, such that consecutive, adjacent links can be attached to each other with the forward ends being in longitudinal alignment with each other.

For example, track link 36A can comprise forward portion 46A, rearward portion 48A and connecting portion 50A, and track link 36B can comprise forward portion 46B, rearward portion 48B and connecting portion 50B. Forward portions 46A and 46B can include forward bores 52A and 52B, respectively, and rearward portions 48A and 48B can include rearward bores 54A and 54B, respectively. Track links 36C and 36D can be configured in the same manner as identified with corresponding reference numerals.

Forward portion 46B can be disposed adjacent to and inward of rearward portion 48A such that forward portion 46B and forward portion 46A can be longitudinally aligned. Forward portion 46B can be coupled to rearward portion 48A at bores 54A and 52B via pin 40. Likewise, forward portion 46D can be disposed adjacent to and inward of rearward portion 48C such that forward portion 46C and forward portion 46D can be longitudinally aligned. Forward portion 46D can be coupled to rearward portion 48C at bores 54C and 52D via pin 40. As such, track links 36B and 36D can rotate relative to track links 36A and 36C about pivot axis A_{P} on pin 40.

Links 36A-36D can include bores 56 for coupling with track shoe 32. Each track shoe 32 can be joined to at least two of the track links 36A-36D by fasteners, such as cap screw type fasteners, bolts, and/or other like. For example, track shoe 32 can be joined to track links 36A and 36C via a plurality of threaded fasteners (not shown) at holes 58. In an example, the fasteners can be threaded fasteners recessed within respective bores 56 and holes 58. For example, a fastener can be inserted through one of holes 58 to engage one of bores 56. A head of the fastener can pull track shoe 32 into engagement with links 36A or 36C as a threaded portion of a shaft of the fastener engages corresponding threading within bore 56. In other examples, the threaded portion of the shaft can pass through bore 56 and extend into opening 60 for coupling with a threaded nut. Opening 60 can be shaped, sized, and/or located to allow an operator to access the end of the threaded fastener with a wrench or other tool for tightening, for example, a nut, washer, and/or another fastening structure.

Track shoe 32 can include substantially rectangular planar base 48 forming a ground-engaging surface of shoe 32. Track shoe 32 can comprise leading edge 62, trailing edge 64 and grouser 66. One or more grousers 66 can be integrally formed with, welded to, or otherwise connected to each shoe 32 to extend outward from base 48 to provide traction for engaging ground.

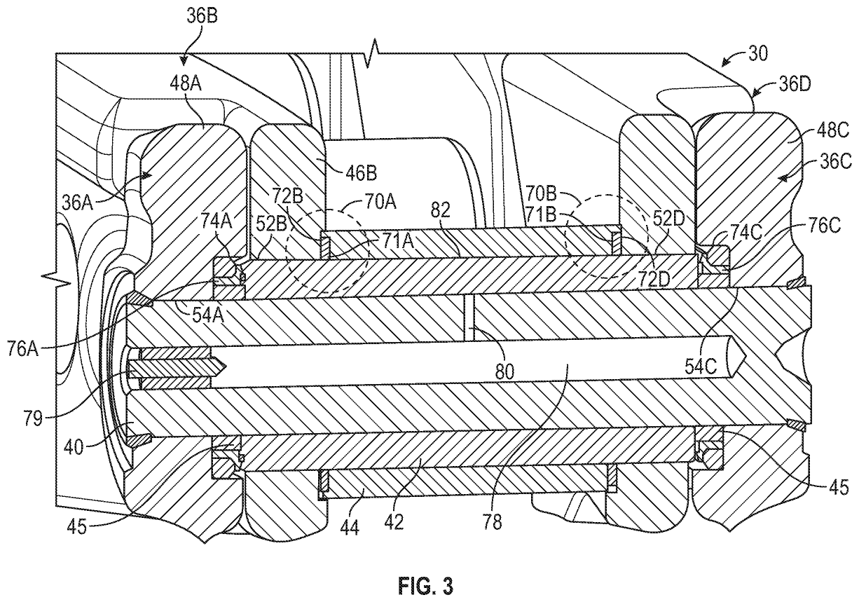

As discussed in greater detail with reference to FIG. 3, pivot assembly 34 can be used to pivotably couple aligned track links on both of sides 38A and 38B and to couple sides 38A and 38B to each other. Pin 40 can directly couple outer, rearward portions 48A and 48C in, for example a non-pivoting fashion. Inner bushing 42 can be disposed within inner, forward portions 46B and 46D about pin 40 so that portions 46B and 46D can rotate freely about pin 40 on inner bushing 42. Outer bushing 44 can be disposed about inner bushing 42 to facilitate engagement with teeth 21 of sprocket 20. As such, inner bushing 42 can reduce wear between a track link and pin 40, and outer bushing 44 can reduce wear between bushing 42 and sprocket 20 (FIG. 1). Seals of the present application can be located, for example, between bushing 44 and portions 46B and 46D to retain lubrication between bushings 42 and 44 and keep dirt, dust, debris and other matter out.

FIG. 3 is a cross sectional view of track link assembly 30 of FIG. 2 showing locations 70A and 70B for irregularly-shaped seals 71A and 71B of the present disclosure. For example, location 70A can comprise a position axially between track link 36B and bushing 44 and radially adjacent track bushing 42. Likewise, location 70B can comprise a position axially between track link 36D and bushing 44 and radially adjacent track bushing 42. Track links 36B and 36D can include counterbores 72B and 72D, respectively, at bores 52B and 52D. Counterbores 72B and 72D can facilitate locating and retaining of irregularly-shaped seals 71A and 71B.

Pin 40 can extend between rearward portions 48A and 48C and couple thereto at bores 54A and 54C. Pin 40 can be secured to rearward portions 48A and 48C via any suitable means, such as by swaging, threading or lock rings. In various examples, pin 40 is non-rotatingly secured to rearward portions 48A and 48C such that rotation of links 36A and 36C causes rotation of pin 40. In other examples, pin 40 can be rotatingly secured to rearward portions 48A and 48C using any suitable means, such as lock rings. In connecting rearward portions 48A and 48C, pin 40 can extend through forward portions 46B and 46D at bores 52B and 52D. Inner bushing 42 can be disposed around pin 40 and can be inserted into bores 52B and 52D. As such, rotation of pin 40 caused by links 36A and 36C can occur within bushing 42, which provides a bearing surface for rotation of links 36B and 36D against pin 40. Likewise, outer bushing 44 is positioned over inner bushing 42 to provide a bearing surface for engagement with teeth 21 of sprocket 20 (FIG. 1).

Irregularly shaped seals 71A and 71B can be disposed within counterbores 72B and 72D to provide sealing of lubrication disposed between bushings 42 and 44. Additionally, rearward portions 48A and 48C can include counterbores 74A and 74C at bores 54A and 54C for reception of seals 76A and 76C, respectively. Each of links 36A 36D can include a counterbore 72 and a counterbore 74 at bores 52 and 54, respectively, Counterbores 72 and 74 can facilitate retention of seals located therein to prevent or inhibit dirt and debris from entering crevices between adjacent rotating components and to prevent or inhibit lubrication provided in said crevices from escaping.

Pin 44 can include inner passage 78 for storing lubrication. Plug 79 can be removed to fill passage 78 with lubrication and plug 79 can be replaced to prevent the filled lubrication from escaping. Passage 78 can connect to the outer diameter of pin 40 via passage 80. Seals 76A and 76D can be located to seal the ends of bushing 42 to prevent lubrication from leaking out from between bushing 42 and pin 40.

The outer diameter of inner bushing 42 can be smaller than the inner diameter of outer bushing 44 so as to form channel 82 therebetween for the reception of lubrication. In an example, channel 82 can be in the range of approximately 0.2 mm to approximately 0.3 mm in radial height relative to pivot axis A_{P} and can be filled with a grease-type lubrication. Irregularly shaped seals 71A and 71B can be located to seal the ends of bushing 44 to prevent lubrication from leaking out from channel 82 between bushing 42 and hushing 44.

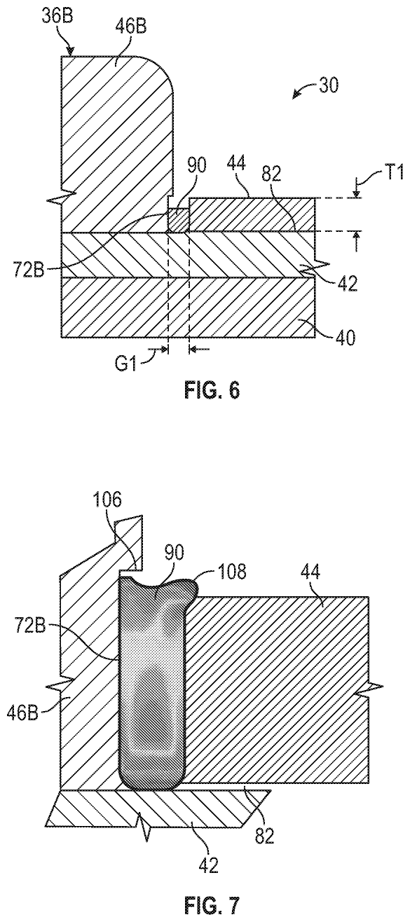

Counterbores 72B and 72B can be provided to facilitate retention of seals 71A and 71B. For example, counterbores 72B and 72D can be taller in the radial direction relative to pivot axis A_{P} (FIG. 2) than the height of seals 71A and 71B to form circumferential surfaces 106 (FIGS. 7 and 11) to face toward seals 71A and 71B.

Seals 714 and 71B can be configured and located to retain lubrication within channel 82 and to keep dirt from getting into channel 82. During operation of machine 10 (FIG. 1), track assemblies 30 can be subject to various rotational and lateral forces. As such, bushings 42 and 44 can be displaced laterally along pivot axis A_{P}, or side-to-side relative to FIG. 3. Seals 71A and 71B located within counterbores 72B and 72D can therefore be subject to various compressive forces, which, can over time wear down the performance of the seal or otherwise be configured in a manner to not provide adequate sealing.

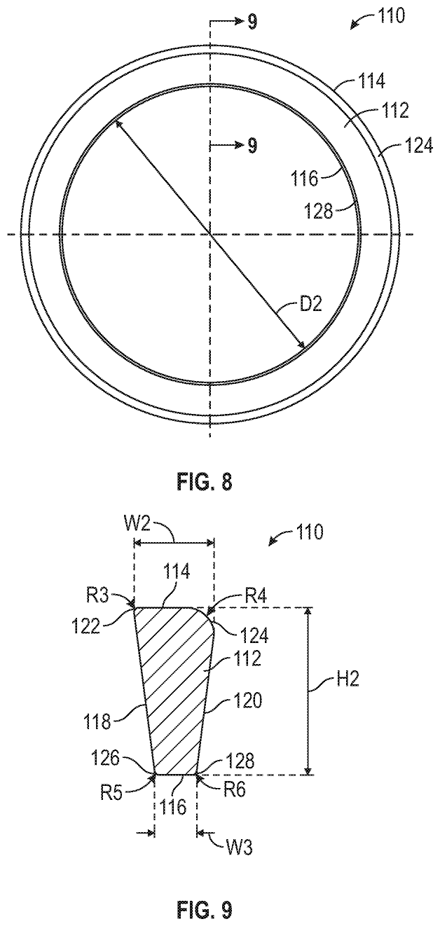

In previous designs, Belleville washers have been used to occupy the space of the gaps G1 (see FIGS. 6 and 8). The Belleville washers were adequate to maintain contact between a bushing and the adjacent track links and to keep large particles of dirt and debris out of the track joint. However, the Belleville washers could sometimes prove to be ineffective in keeping out fine particles and sealing-in lubrication. The present inventors have recognized the need for more effective sealing in track joint assemblies such as through the use of deformable seals. The present inventors have also recognized that conventional O-ring seals having rectangular or square cross-sectional profiles can be inadequate for sealing track joint assemblies in a wide variety of loading conditions. For example, seals having uniform cross-sectional profiles can be too stiff to seal the joint when subject to compressive loading from the bushing because, for example, the seals do not allow space within the counterbores for the seals to expand. Thus, the seals cannot always adequately deform to seal against the bushing. The present inventors have provided a solution to this problem and other problems by developing irregularly shaped seals having cross-sectional profiles that strategically deform to fill the gap space between a bushing and a counterbore of a track link. For example, the irregularly-shaped seals can be shaped to leave spaces or voids within the counterbores that permit the seals to compress in particular locations and expand in other locations under loading to better fill the gap between bushing 44 and the adjacent counterbore.

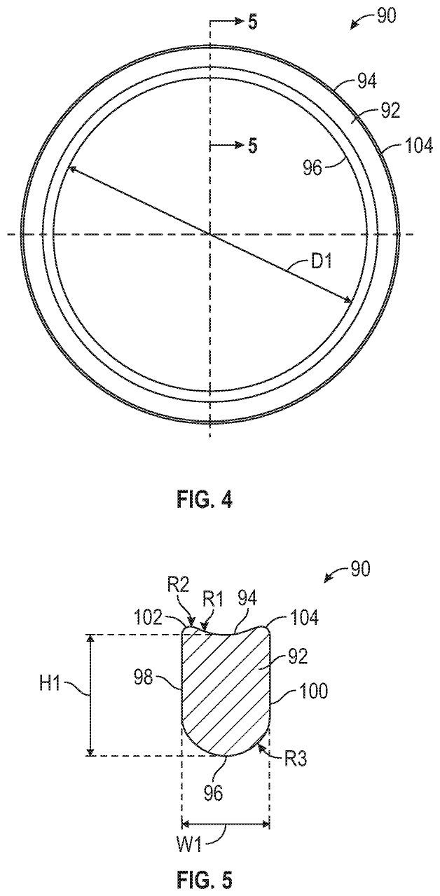

FIG. 4 is a side view of a first embodiment of irregular-shaped seals 71A and 71B of track assembly 30 of FIG. 3 comprising seal 90 having a curved rectangular profile. FIG. 5 is a cross-sectional view of seal 90 of FIG. 4 showing the curved rectangular profile. FIGS. 4 and 5 are discussed concurrently.

Seal 90 can comprise body 92, outer diameter wall 94, inner diameter wall 96, first sidewall 98 and second sidewall 100. Body 92 can form a closed-loop or ring. In an example, seal 90 comprises an O-ring seal having a circular shape. In other examples, seal 90 can have other closed-loop shapes. Outer diameter wall 94 can comprise a concave shape relative to the exterior of body 92. The curvature of outer diameter wall 94 can have radius R1. Outer diameter wall 94 can be joined to first and second sidewalls 98 and 100 via curved surfaces 102 and 104, each having radius R2. First sidewall 98 and second sidewall 100 can comprise straight surfaces that are parallel to each other. In an example, sidewalls 98 and 100 can be spaced apart so body 92 has width W1. Inner diameter wall 96 can comprise a convex shape relative to the exterior of body 92. The curvature of inner diameter wall 96 can have radius R3. In an example, radius R3 can be equal to radius R1. Radii R1 and R3 can have the same center such that outer diameter wall 94 and inner diameter wall 96 can be concentric. In an example, inner diameter wall 96 joins with sidewalls 98 and 100 such that body has height H1.

In an example, body 92 can have an inner diameter D1 at inner diameter wall 96. Inner diameter D1 can be configured to mate with the outer diameter of bushing 42, as shown in FIG. 6. In various examples, inner diameter D1 can be slightly smaller than the outer diameter of bushing 42 and body 92 can be configured to stretch to fit over bushing 42, thereby facilitating a sealing engagement. In an example, body 92 can be comprised of urethane. However, in other examples, other materials can be used, such as rubber, plastic and other polymers that have good abrasion resistance and flexibility properties. The shape, geometry, size and dimensions of seal 90 are configured to interact with bushing 42 and bushing 44 relative to counterbores 724 and 72B in track link 36B, as shown in FIGS. 6 and 7.

FIG. 6 is a cross-sectional view of seal 90 of FIG. 5 located within track link assembly 30 in an uncompressed state. Seal 90 is disposed to surround bushing 42 at an outer diameter surface thereof, and to be disposed between track link 36B and bushing 44, Another seal 90 can be disposed between track link 36D and bushing 44 on an opposite end thereof. Seal 90 can be configured to fill in the axial spaces between track links 36B and 36D and bushing 44. Track links 36B and 36D (FIG. 3) and bushing 44 are sized such that gap (31 will be disposed between bushing 44 and track links 36B and 36D. In a nominal state, width W1 of seal 90 will fill in gap G1 on either end of bushing 44. That is, the total width of bushing 44 plus two of seals 90 can equal the distance between track links 36B and 36D at counterbores 72B and 72D (FIG. 3). In an example, width W1 of body 92 can be equal to gap G1 in an uncompressed state of seal 90. Additionally, height H1 of seal 90 can be less than radial thickness T1 of bushing 44, as shown in FIG. 6. Radial thickness T1 of bushing 44 can be slightly less than the radial height of counterbore 72B at circumferential surface 106 (FIG. 7). Thus, in an uncompressed state, seal 90 can hug the outer diameter of bushing 42 and can press against bushing 44 to seal channel 82.

However, bushing 44 does not typically remain in one axial position on bushing 42 during operation of machine 10 (FIG. 1). As such, bushing 44 can axially slide along bushing 42 to shrink gap G1 on one side of bushing 44 and expand gap G1 on the other side of bushing 44. In such a scenario, body 92 of seal 90 can deform in a predetermined way as determined by the irregular cross-sectional shape of seal 90 to maintain sealing against bushings 42 and 44.

FIG. 7 is a cross-sectional view of seal 90 of FIG. 6 located within track link assembly 30 in an axially compressed state. Bushing 44 can translate closer to track link 36B during operation of machine 10 (FIG. 1) to shrink the size of gap G1 to less than width W1 of seal 90. Under such conditions, the height H1 of seal 90 can grow to greater than thickness T1 of bushing 44 such that material of body 92 can push out beyond the outer diameter of bushing 44, but without contacting outer circumferential surface 106 of counterbore 72B. The concavity of outer diameter wall 94 can permit displacement of seal material radially outward, which can facilitate formation of lobe 108 that can extend axially over bushing 44 to seal thereagainst without overstressing seal 90. The radial convexity of inner diameter wall 96, which is constrained by bushing 42, can provide spaces or voids within counterbore 72B to allow material of seal 90 to expand axially to maintain axial sealing between track link 36B and bushing 44. Seal 90 of FIGS. 4-7 can thus be configured to primarily seal between bushing 44 and track link 36B at a radially inner end of body 92, while providing secondary sealing with lobe 108 at a radially outer end of body 92.

FIG. 8 is a side view of a second embodiment of irregular-shaped seals 71A and 71B of track assembly 30 of FIG. 3 comprising seal 110 having a trapezoidal profile, FIG. 9 is a cross-sectional view of seal 110 of FIG. 8 showing the trapezoidal profile, FIGS. 8 and 9 are discussed concurrently.

Seal 110 can comprise body 112, outer diameter wall 114, inner diameter wall 116, first sidewall 118 and second sidewall 120. Body 112 can form a closed-loop or ring. In an example, seal 110 comprises an O-ring seal having a circular shape. In other examples, seal 110 can have other closed-loop shapes.

Outer diameter wall 114 and inner diameter wall 116 can comprise straight surfaces that are parallel to each other. In an example, walls 114 and 116 can be spaced apart so body has height H2. Outer diameter wall 114 can be joined to first and second sidewalls 118 and 120 via curved surfaces 122 and 124, which can have radii R3 and R4, respectively. In an example, radius R4 can be greater than radius R3. First sidewall 118 and second sidewall 120 can comprise straight surfaces that are oblique to each other. First sidewall 118 and second sidewall 120 can form complementary angles with outer diameter wall 114 and inner diameter wall 116. In an example, sidewalls 118 and 120 can be spaced apart at their radial outer end so body 112 has width W2 thereat, and sidewalls 118 and 120 can be spaced apart at their radial inner end so body 112 has width W3 thereat. Inner diameter wall 116 can be joined to first and second sidewalls 118 and 120 via curved surfaces 126 and 128, which can have radii R5 and R6, respectively. In an example, radius R5 can be equal to radius R6.

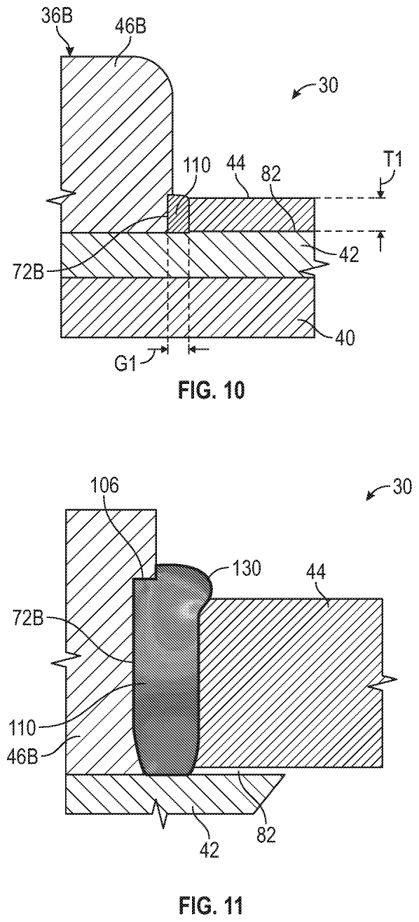

In an example, body 112 can have an inner diameter D2 at inner diameter wall 116. Inner diameter D2 can be configured similarly to inner diameter D1 of FIGS. 4 and 5 to, for example, secure tightly around bushing 42. In an example, body 112 can be comprised of urethane. However, in other examples, other materials can be used, such as rubber, plastic and other polymers that have good abrasion resistance and flexibility properties. The shape, geometry, size and dimensions of seal 110 are configured to interact with bushing 42 and bushing 44 relative to counterbores 72A and 72B in track link 36B, as shown in FIGS. 10 and 11.

FIG. 10 is a cross-sectional view of seal 110 of FIG. 8 located within track link assembly 30 in an uncompressed state. Seal 110 is disposed to surround bushing 42 at an outer diameter surface thereof, and to be disposed between track link 36B and bushing 44. Another seal 110 can be disposed between track link 36D and bushing 44 on an opposite end thereof. Seal 110 can be configured to fill in the axial spaces between track links 36B and 36D and bushing 44. Track links 36B and 36D (FIG. 3) and bushing 44 are sized such that gap G1 will be disposed between bushing 44 and track links 36B and 36D. In a nominal state, width W2 of seal 110 will fill in gap G1 on either end of bushing 44. That is, the total width of bushing 44 plus two of seals 110 can equal the distance between track links 36B and 36D at counterbores 72B and 72D (FIG. 3). In an example, width W2 of body 112 can be equal to gap G1 in an uncompressed state of seal 110. Additionally, height H2 of seal 110 can be approximately equal to the radial height of counterbore 72B, which can be greater than radial thickness T1 of bushing 44, as shown in FIG. 10. Radial thickness T1 of bushing 44 can be slightly less than the radial height of counterbore 72B at circumferential surface 106 (FIG. 11). Thus, in an uncompressed state, seal 110 can hug the outer diameter of bushing 42 and can press against bushing 44 to seal Channel 82, while also pushing against circumferential surface 106.

However, bushing 44 does not typically remain in one axial position on bushing 42 during operation of machine 10 (FIG. 1). As such, bushing 44 can axially slide along bushing 42 to shrink gap G1 on one side of bushing 44 and expand gap G1 on the other side of bushing 44. In such a scenario, body 112 of seal 110 can deform in a predetermined way as determined by the irregular cross-sectional shape of seal 110 to maintain sealing against bushings 42 and 44.

FIG. 11 is a cross-sectional view of seal 110 of FIG. 8 located within track link assembly 30 in an axially compressed state. Bushing 44 can translate closer to track link 36B during operation of machine 10 (FIG. 1) to shrink the size of gap G1 to less than width W2 of seal 110. Under such conditions, the height H2 of seal 110 can grow to greater than the radial height of counterbore 72A such that material of body 112 can push out beyond the outer diameter of bushing 44 and contact outer circumferential surface 106 of counterbore 72B. The width W2 of outer diameter wall 114 can permit displacement of seal material radially outward, which can facilitate formation of lobe 130 that can extend axially over hushing 44, to seal between outer circumferential surface 106 and bushing 44 without overstressing seal 110. Radius R4 can be greater than radius R3 to promote formation of lobe 130. For example, curved wall 122 can push against counterbore 72B at circumferential surface 106 to promote expansion of material at curved surface 124. The width W3 of inner diameter wall 116, which is constrained by bushing 42, can provide spaces or voids within counterbore 72B to allow material of seal 110 to expand axially to maintain axial sealing between track link 36B and bushing 44. Seal 110 of FIGS. 8-11 can thus be configured to primarily seal between bushing 44 and track link 36B with lobe 130 at a radially outer end of body 112, while providing secondary sealing at a radially inner end of body 112.

### INDUSTRIAL APPLICABILITY

The present application describes various devices, systems and methods for track systems that incorporate a seal configured to retain lubrication between rotating components, while also keeping dirt and debris out. The seals can be configured to have irregular, non-uniform or varying geometric shapes such that when deformed, the seals undergo an irregular, strategic displacement of material that can shift shape to seal between various adjacent surfaces without overstressing the seal or being too rigid to allow for deformations conducive to sealing. For example, wider portions of the seal can deform before narrower portions of the seal to provide initial sealing in a desired area. The narrower portions of the seal can facilitate shifting of material from the wider portion to a desired area. Because the seal is not uniformly engaged under loading all at once, the seal does not provide a rigid resistance to loading that can inhibit effective sealing between adjacent components. As such, the seals are effective in maintaining a tight seal between adjacent components in stressed and unstressed conditions and are therefore useful in sealing between components of a track assembly to keep lubrication in and foreign matter out, in particular, the irregularly shaped seals described herein are effective in sealing between concentric bushings in a rotating sleeve track wherein the outer bushing is subject to axial compression against a track link counterbore. Such irregularly shaped seals improve sealing capabilities over washer-type seals such as Belleville washers and conventional O-ring seals having regular or uniform cross-sectional profiles, which are ineffective at sealing lubrication and sealing under loading, respectively. The seals and sealing arrangements described herein can be applied to other rotating components in track-type vehicles, such as idlers, rollers and wheels.

What is claimed is:

1. A track joint assembly comprising:
a first track link comprising a first through bore;
a second track link comprising:
a second through bore; and
a counterbore;
a pin extending through the first through bore and the second through bore;
a first bushing surrounding the pin within the second through bore;
a second bushing surrounding the first bushing adjacent the counterbore; and
a seal disposed in the counterbore, the seal comprising:
a seal body surrounding the first busing, the seal body having an irregular cross-sectional area configured to non-uniformly seal a gap between the counterbore and the second bushing.

2. The track joint assembly of claim 1, wherein the irregular cross-sectional area comprises a curved rectangular profile.

3. The track joint assembly of claim 2, wherein the curved rectangular profile comprises:
a first pair of straight parallel sides; and
a second pair of curved concentric sides.

4. The track joint assembly of claim 3, wherein the second pair of curved concentric sides comprises:
a first convex side configured to engage the first bushing; and
a second concave side configured to face toward a circumferential surface of the counterbore.

5. The track joint assembly of claim 4, wherein the first pair of straight parallel sides are joined to the first concave side at first and second curved surfaces having radii that are equal.

6. The track joint assembly of claim 1, wherein the irregular cross-sectional area comprises a trapezoidal profile.

7. The track joint assembly of claim 6, wherein the trapezoidal profile comprises:
a first pair of straight oblique sides disposed between the counterbore and the second busing; and
a second pair of straight parallel sides connecting the first pair of straight oblique sides.

8. The track joint assembly of claim 7, wherein the first pair of straight oblique sides comprises:
a narrow end configured to engage the first bushing; and
a wide end configured to engage the counterbore.

9. The track joint assembly of claim 8, wherein the first pair of straight oblique sides are joined to the wide end of the second pair of straight parallel sides at first and second curved surfaces having radii that are different.

10. The track joint assembly of claim 1, wherein the seal comprises a urethane material.

11. A ring seal having an irregularly shaped cross-sectional profile to seal a pivot assembly of a track assembly, the ring seal comprising:
a body comprising:
an inner diameter wall;
an outer diameter wall;
a first sidewall; and
a second sidewall;
wherein at least one pairing of the inner and outer walls and the first and second sidewalls are non-parallel.

12. The ring seal of claim 11, wherein the body defines a curved rectangular profile comprising:
the first side wall and the second sidewall being straight and parallel to each other;
the inner diameter wall having a convex curved shape; and
the outer diameter wall having a concave curved shape;
wherein the convex curved shape and the concave curved shape have the same radius of curvature.

13. The ring seal of claim 11, wherein the body defines a trapezoidal profile comprising:
the outer diameter wall and the inner diameter wall being straight and parallel to each other;
the first sidewall being straight and extending oblique to the outer and inner diameter walls; and
the second sidewall being straight and extending oblique to the outer and inner diameter walls:
wherein the first sidewall is longer than the second sidewall due to the first sidewall and the second sidewall connecting to the outer diameter wall with different radii.

14. The ring seal of claim 11, further comprising:
a first track assembly bushing disposed within the O-ring seal; and
a second track assembly bushing disposed about the first track assembly bushing adjacent the O-ring seal;
wherein the O-ring seal comprises:
a first diameter smaller than an outer diameter of the first track bushing; and
a second diameter less than an outer diameter of the second track bushing.

15. The ring seal of claim 11, wherein the body comprises a urethane material.

16. A bushing assembly for a track assembly, the bushing assembly comprising:
an inner bushing having an outer diameter surface;
an outer bushing having a through bore extending from a first end of the outer bushing to a second end of the outer bushing and defining an inner diameter surface:
a passage disposed between the outer diameter surface and the inner diameter surface; and
a closed-loop seal having a non-uniform cross-sectional profile located on the outer diameter surface against the first end of the outer bushing to seal the passage.

17. The bushing assembly of claim 16, wherein the non-uniform cross-sectional profile of the closed-loop seal comprises:
a radially inner surface that is convex;
a radially outer surface that is concave;
a first side wall connecting the radially inner and radially outer surfaces; and
a second side wall connecting the radially inner and radially outer surfaces, the first and second side walls being parallel.

18. The hushing assembly of claim 17, further comprising:
a first curved surface joining the radially outer surface and the first side wall, the first curved surface having a first radius; and
a second curved surface joining the radially outer surface and the second side wall, the second curved surface having a second radius;
wherein the first radius and the second radius are equal.

19. The hushing assembly of claim 16, wherein the non-uniform cross-sectional profile of the closed-loop seal comprises:
a first side wall that is straight;
a second side wall that is straight, the first and second side walls being oblique;
a radially outer surface connecting the radially inner and radially outer surfaces;
a radially inner surface connecting the radially inner and radially outer surfaces, the radially inner and radially outer surfaces being parallel.

20. The bushing assembly of claim 19, further comprising:
a first curved surface joining the radially outer surface and the first side wall, the first curved surface having a first radius; and
a second curved surface joining the radially outer surface and the second side wall, the second curved surface having a second radius;
wherein the first radius and the second radius are different.
